(19) United States
(12) Patent Application Publication
(10) Pub. No.: US 2004/0230602 A1
(43) Pub. Date: Nov. 18, 2004

(54) System and method for decoupling data presentation layer and data gathering and storage layer in a distributed data processing system

(76) Inventor: Andrew Doddington, London (GB)

Correspondence Address: MICHAEL B. JOHANNESEN, ESQ., LOWENSTEIN SANDLER, P.C., 65 LIVINGSTON AVENUE, ROSELAND, NJ, 07068, US

(21) Appl. No.: 10/667,690

(22) Filed: Sep. 22, 2003

Related U.S. Application Data
(60) Provisional application No. 60/470,576, filed on May 14, 2003.

(51) Int. Cl. G06F 7/00

(52) U.S. Cl. 707/102

(57) ABSTRACT

A system and method for use in a data network that effects decoupling of the presentation layer and the business layer, while enhancing the flexibility and utility of both. A new framework is provided that decouples the presentation and business layers by providing a software protocol that allows the necessary details of the communication between the two layers to be expressed unambiguously, while avoiding the common tendency to include unnecessary details, such as the manner in which the data and or functions are to be presented to the user. In this manner, the flexibility both in terms of the manner in which the displays may evolve over time and the degree to which new business functions may be added to the business layer greatly increases.

### FIELD OF THE INVENTION

This invention relates to the field of distributed data processing systems, and, more specifically, to a system and method for decouplng a data presentation layer from a data gathering, processing and storage layer so that a programmer working on one layer does not need to understand information about the other layer.

### BACKGROUND OF THE INVENTION

Today's businesses are data driven. Sophisticated data networks collect data, store data, analyze data, present data to users, etc., so that a user of this data may make informed decisions. The amount and types of data being collected is ever-changing in this modern economy. So too are the ways in which such data is amalgamated and then presented to users. Because of the amount and types of data, and the differing needs of the users, data networks are structured into discrete tasks or “layers” to facilitate customized data views for the users.

FIG. 1 is one example of such a data network, shown generally at 100. Data network 100 is illustrated generally as having a user layer 102, a presentation layer 104 and a business layer 106. Generally, user layer 102 presents data and receives input from users. Business layer 106 collects and stores data and executes transactions requested by the users. Presentation layer 104 receives data and a set of functions that may be performed from business layer 106 and presents such data and functions to user layer 102 in multiple formats, each tailored to the needs of a particular user.

Following the presentation of data and functions to the user, the user may select a function from the set of functions that is presented to him/her. The selection of a function typically causes a function request to be sent to business layer 106. The cycle of data gathering, processing, presenting and selecting then repeats.

In the user layer 102, a first data network 108 provides a communications interface between end user devices in user layer 102 and servers in presentation layer 104. A plurality of data display and transaction devices, represented by workstation 110 and PC 112, connect directly to the first network 108. Alternatively, a further plurality of display devices, represented by terminals 114 and 116, communicate with the first data network 108 via an application running on server 118.

Presentation layer 104 comprises one or more servers, represented by server 120. Server(s) 120 receives requests for data from users in user layer 102 and interacts with business layer 106 to provide such data in a form usable by user layer 102.

Business layer 106 comprises a second data network 130 that interconnects server(s) 120 in presentation layer 104 to a plurality of servers, represented by servers 132, 134 and 136 in business layer 106. Server 132 represents a database server 138 and server 134 represents a long-term storage server 140.

While the first data network 108 and the second data network 130 are illustrated herein as two separate networks, they may be the same network in practice. Furthermore, data network 100 is exemplary and many variations on this theme are known in the art.

Typically, the communication between user layer 102 and presentation layer 104 is reasonably well-defined and based on existing standards, such as HTML. The communication between presentation layer 104 and business layer 106, in direct contradistinction, is poorly defined. In the current art, presentation layer 104 must have at least some knowledge of the structure of business layer 106 so that it knows what data and functions are available to it. Likewise, business layer 106 generally has some knowledge of how presentation layer 104 wants to receive data for further presentation to users.

This interlocking of presentation layer 104 and business layer 106 requires that, when one is changed, the other needs to be at least checked that there is no unwanted effect on the other. Thus, there is a need in the art to decouple the presentation layer from the business layer, so that communications operate smoothly and a change in one layer does not affect the other layer.

### SUMMARY OF THE INVENTION

This problem is solved and a technical advance is achieved in the art by a system and method that effects decoupling of the presentation layer and the business layer, while enhancing the flexibility and utility of both. A new framework is provided that decouples the presentation and business layers by providing a software protocol that allows the necessary details of the communication between the two layers to be expressed unambiguously, while avoiding the common tendency to include unnecessary details, such as the manner in which the data and or functions are to be presented to the user. In this manner, flexibility both in terms of the manner in which the displays may evolve over time and the degree to which new business functions may be added to the business layer greatly increases.

### BRIEF DESCRIPTION OF THE DRAWINGS

A more complete understanding of this invention may be obtained from a consideration of this specification taken in conjunction with the drawings, in which:

FIG. 1 is a simplified block diagram of the context of both the prior art and of an exemplary embodiment of this invention;

FIG. 2 is a block diagram of the core classes and interfaces to support a decoupled interface between the presentation layer and the business layer in accordance with the exemplary embodiment of this invention;

FIGS. 3-14 are sample Class definitions for the purpose of illustrating operation of the exemplary embodiment of this invention; and

FIGS. 15-17 are exemplary transport networks that an exemplary embodiment of this invention may use.

### DETAILED DESCRIPTION

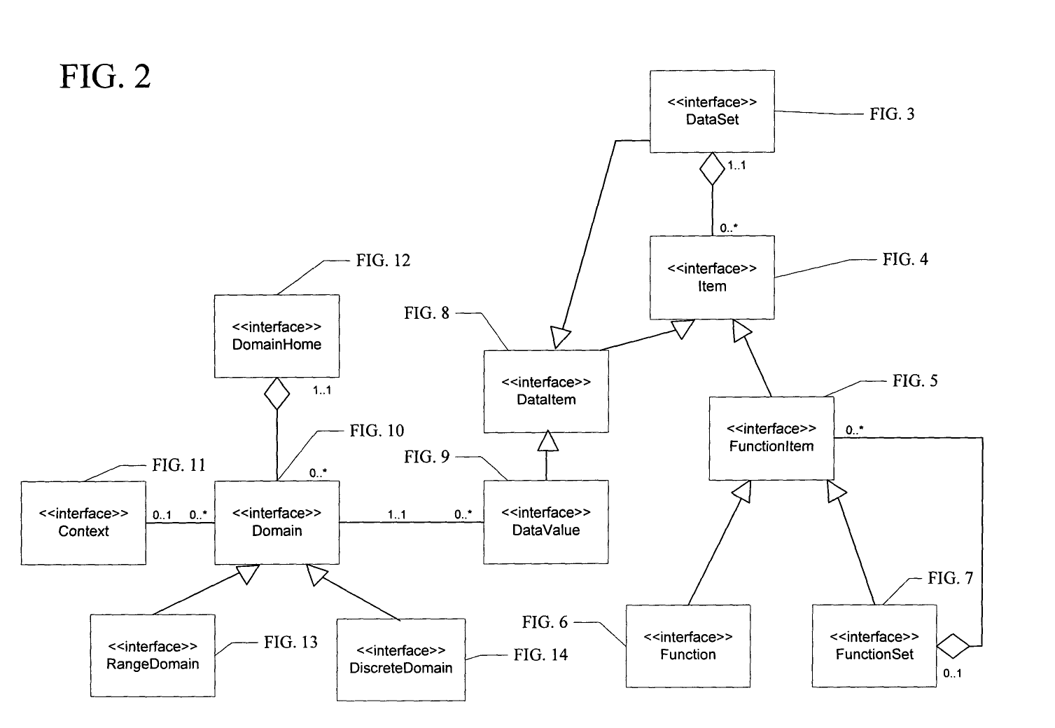

FIG. 2 is a diagram of the core classes and interfaces to support a decoupled interface between the presentation layer and the business layer in accordance with the exemplary embodiment of this invention. Given that the diagram refers to interfaces rather than classes, the inheritance relationship should be read as “extends” while associations/aggregations should be taken as being implied in the implementation, rather than being explicit relationships.

The framework essentially consists of a hierarchy of “Items” (comprising either data items or functions), which use the standard Composite pattern to allow for arbitrary nesting of substructures structures (see, E. Gamma, R. Helm, R. Johnson and J. Vlissides; Design Patterns, for documentation on Composite patterns). The remainder of this section consists of a definition/description of each interface in the framework, using the Java language as the primary notation. The reasons for using Java include:

It is a well defined and well understood notation;

The Java language already supports the concept of abstract interfaces;

It maps easily onto the proposed implementation (which will be in Java); and

It reduces the tendency to focus on the underlying transport, and places it on the API that will be presented to the client code.

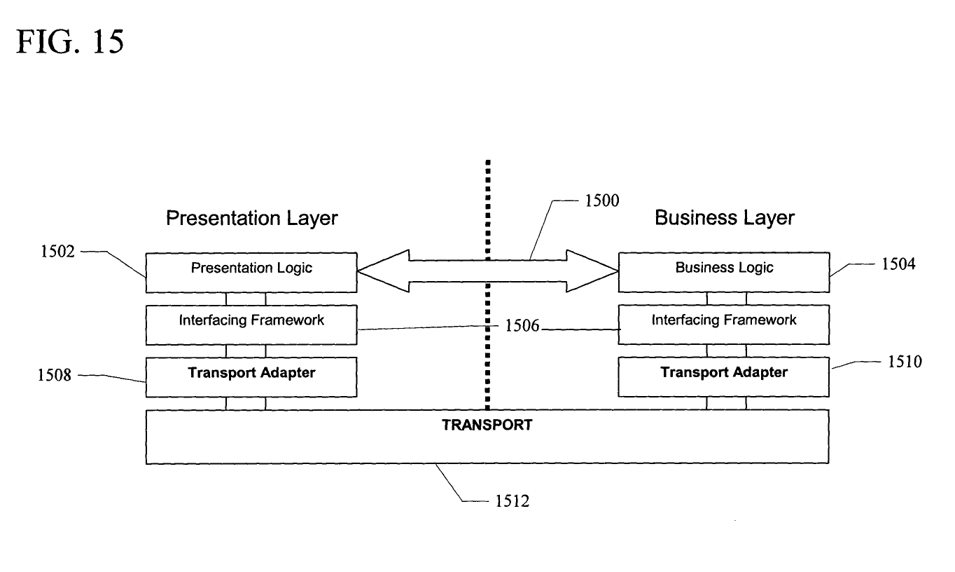

In practice, a Java implementation should map easily onto whatever transport is chosen, including SOAP (e.g., using the Apache/Axis “Bean Serializer” class) or RMI (since all relevant interfaces extend the Java “Serializable” interface), as will be discussed below, in connection with FIGS. 15-17.

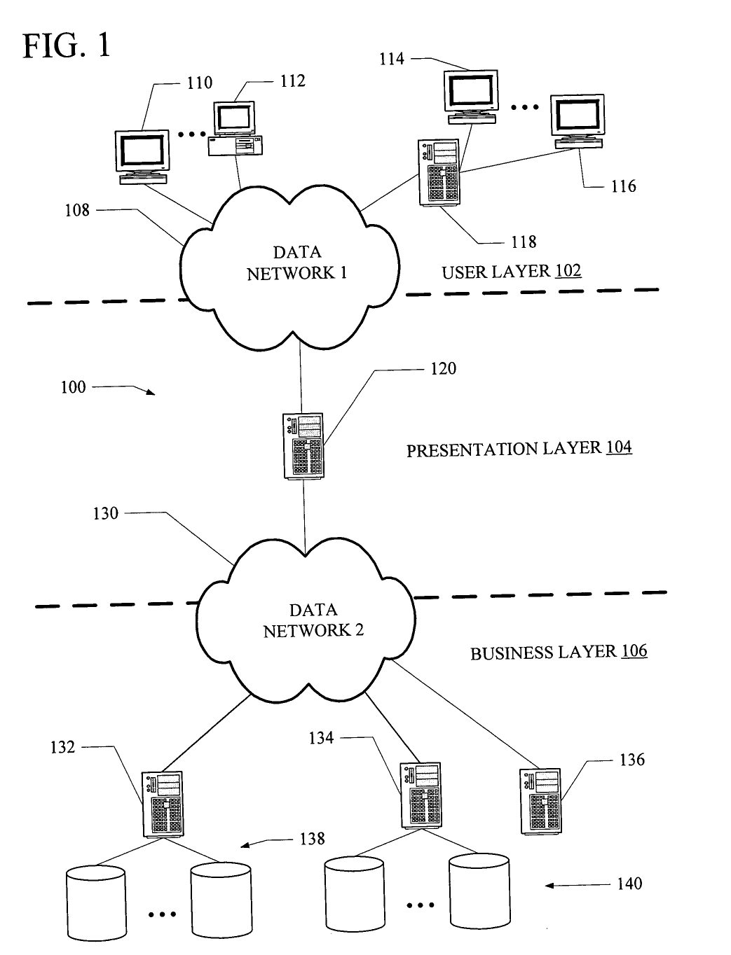

Each box in FIG. 2 is defined in its own figure, described further below. The interface defined in FIG. 2 runs in all presentation layer servers 120 (FIG. 1) and all business layer servers 132, 134 and 136 (FIG. 1). While the exemplary embodiment of FIG. 2 is intended to run on all presentation layer servers and business layer servers, it will be clear to one skilled in the art how to use this interface effectively in other configurations after studying this specification. To facilitate clarity, each figure is given a heading, below.

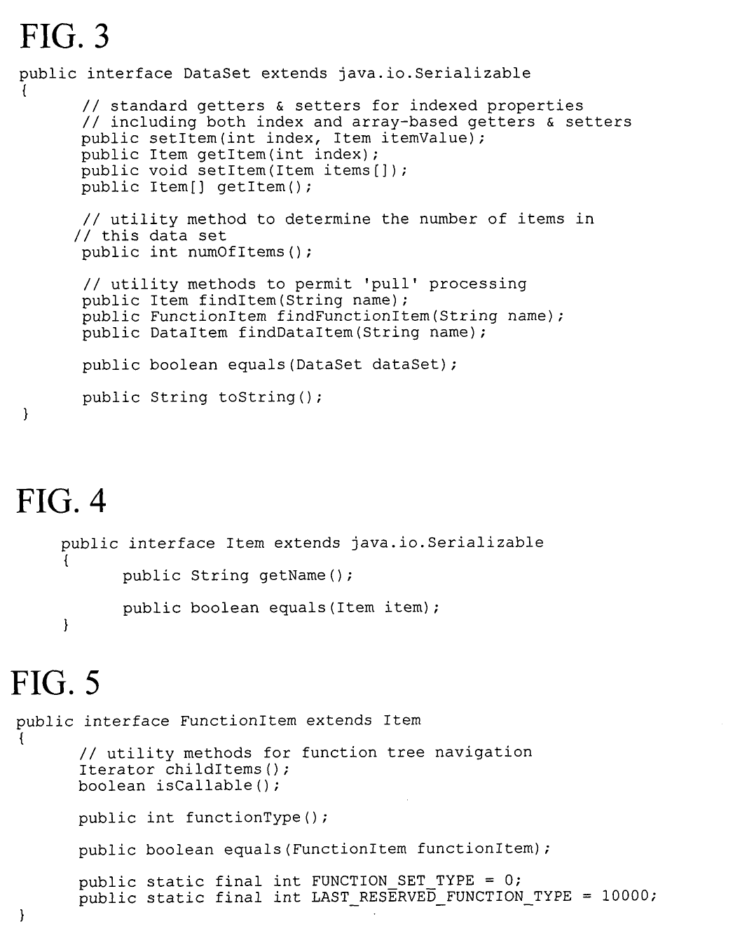

FIG. 3, DataSet

An exemplary DataSet class is shown in FIG. 3. The DataSet class represents an arbitrary set of data items and corresponds to the main unit of communication between the presentation layer 104 and the business layer 106 that it relies upon. Standard bean methods are provided to access the Items within this set. The ordering of items is determined by the creator of the DataSet and may be used to derive further semantics. A number of additional utility methods are provided to access the contents of the DataSet, including methods to support “pull” operations (defined further, below).

FIG. 4, Item

An exemplary Item is illustrated in FIG. 4. This represents a trivial abstraction, corresponding to little more than “a ‘thing’that can be in a DataSet”; as such, it has little intrinsic behavior apart from the fact that it has a name. Items are defined to be serializable to support DataSet Serialization.

FIG. 5, FunctionItem

An exemplary FunctionItem is illustrated in FIG. 5. This is a trivial abstraction that exists primarily to group those items that represent Functions, as opposed to those that correspond to data (see FIG. 8). The “childltems( )” and “isCallable( )” methods are provided as a convenience, to allow the function tree structure to be navigated without regard to the type of FunctionItem that is being processed, e.g., to generate a simple tree structure. These functions should return an empty Iterator and false, respectively, if the FunctionItem is a FunctionSet.

The “functionType( )”method is provided to allow functions to be grouped into sets of similar functions, such as “layout,” “pagination,” “search,” “business,” etc. This area may be implemented as a series of static constants, as shown above. As indicated, it is suggested that a value of zero is reserved to denote FunctionSets (FIG. 7). In addition, by grouping the values within fixed ranges, one or more ranges may be set-aside for business-specific function types—to be agreed between the presentation layer 104 and business layer 106 services.

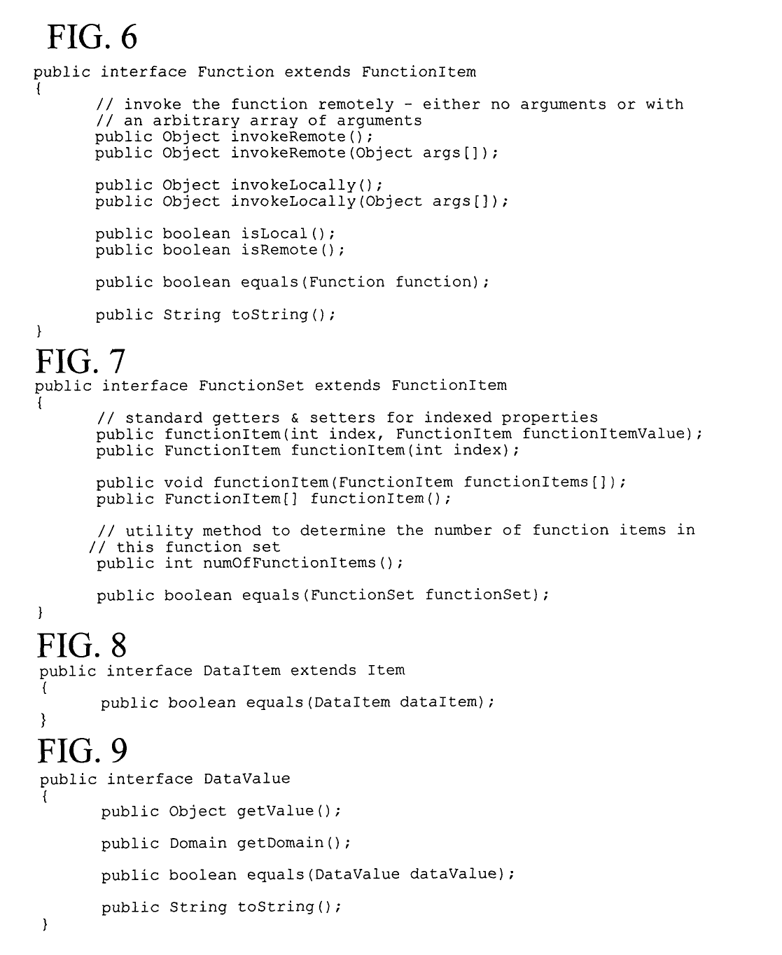

FIG. 6, Function

FIG. 6 is an example of a Function. This represents some form of behavior that may be invoked on the DataSet (FIG. 3) in which it is contained. As an example, a Function defined within the top-most DataSet (FIG. 3) can be applied to that level (and may access any descendant items below that point). By contrast, a Function appearing at a lower level in the DataSet (FIG. 3), such as within a “row” of data (contained in a set of such rows) can only be invoked for that particular row of data—though once again, it may access descendants of the row. [Note: The mechanism by which a Function is invoked on a DataSet (FIG. 3) should be implemented in such a way as to minimize the risk of such mismatches occurring.]

Although most functions will generally be executed remotely by sending a request to the business layer 106 service, some may be executed locally within presentation layer 104 servers 120. This decision will depend both on the nature of the operation and the level of functionality provided by the business layer 106 services. Two methods are therefore provided to test whether the function may be invoked locally or remotely. Note that although in some cases both conditions may be true, at least one of them must be true in all cases.

FIG. 7, FunctionSet

FIG. 7 is an example of a FunctionSet. Functions have the option of existing in a hierarchy, which is orthogonal to the DataSet (FIG. 3) structure. The FunctionSet interface is used to represent such collections of FunctionItems FIG. 5 (i.e., Functions FIG. 6 and FunctionSets FIG. 7). Note that the position of a function in such a hierarchy has very little meaning, and only exists to provide the presentation layer 104 with a hint as to the logical relationship between the functions that are available at a given point. That is, all functions in a given DataSet (FIG. 3) are essentially equivalent, regardless of where they might appear in a function hierarchy.

FIG. 8, DataItem

FIG. 8 is an example of a DataItem. This is a trivial abstraction that exists primarily to group those items that contain data, as opposed to those that correspond to Functions (see FIG. 5).

FIG. 9, DataValue

FIG. 9 is an example of a DataValue. This is the root interface for all simple data values, i.e., all data values other than nested Data Sets. The “getter” that is provided to obtain the item's “value” assumes that this is returned as an object. It is anticipated that sub-classes provide type-specific getters, e.g. an IntegerValue class might provide a “getAslnt( )” method that returns an “int” result. The “getDomaino” method allows the data type of the item to be obtained at run-time, e.g., to allow drop-down lists to be populated at the presentation layer.

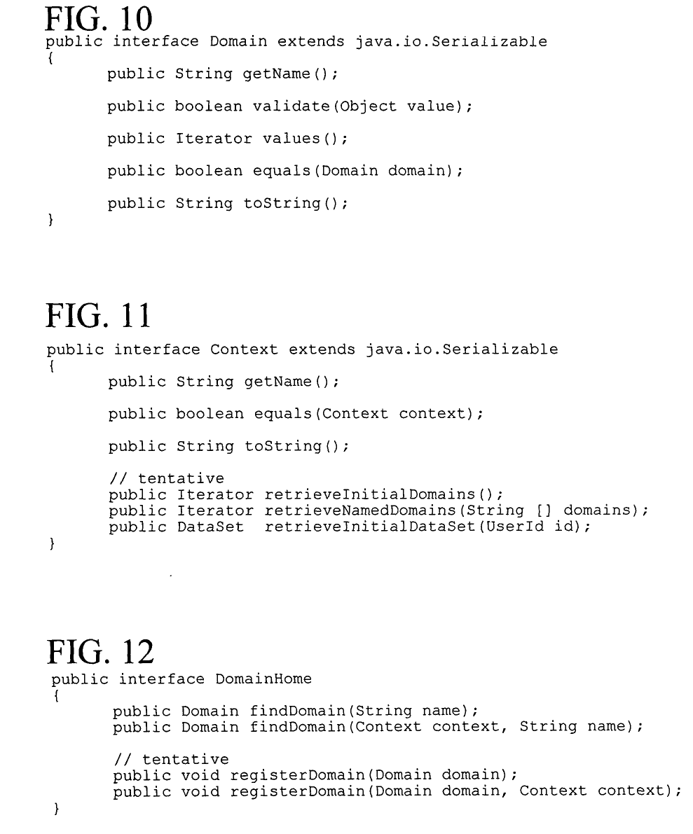

FIG. 10, Domain

FIG. 10 is an example of a Domain. This corresponds to the common concept of a data type and may be associated with one or more DataItems (FIG. 8). Since Domains are essentially read-only, they may be safely shared amongst multiple Data Items, including use across multiple threads. Examples of common domains include:

The java String and Number classes;

Global reference data such as country codes;

Business-specific data, such as product types that are supported by a particular business layer; and

User-specific data such as lists of counterparties whose trades are accessible to a particular user.

Each Domain will typically be associated with a Context (see FIG. 11) which helps to distinguish otherwise identical Domains. If a Domain is not associated with a specific Context, then it is assumed to belong to a global context that is common to all environments. All Domains are serializable in order to simplify their transfer between the presentation layer 104 and business layer 106 services.

Methods are provided to allow arbitrary objects to be tested to determine whether they are valid members of the Domain, i.e., whether they may be used to assign a value to a Data Item belonging to this Domain. The “values( )” method can be used to return a list of allowed values, where this is appropriate. A null result will be returned if this is not possible.

FIG. 11, Context

FIG. 11 is an example of a Context. Since domains with the same name may exist in a number of different contexts (e.g., clients or servers) the concept of a Context is introduced to help distinguish between otherwise identical Domains (FIG. 10). A Context will generally map implicitly onto a server or client system, such that all Domains that are provided by that system are implicitly associated with the corresponding Context. It is likely that different implementations of this interface will exist, corresponding to the different mechanisms that are used to identify clients and servers.

The “retrieveInitialDomains( )” method is intended to be used at start-up (see below), to allow a client to retrieve an initial set of Domains that are used by a service, using the service to determine the optimal set of Domains. The result is returned using an Iterator, to allow for lazy retrieval.

The “retrieveInitialDataSet( )” method is called whenever a user begins using a business layer 106 service, as described further, below. The returned DataSet will typically contain very little data and is primarily intended to return the initial set of functions that the user may invoke. Note that this method presumes the existence of a UserId class, which is outside the scope of this specification, but is well known to one skilled in the art.

FIG. 12, DomainHome

FIG. 12 is an example of a DomainHome. Since Domains are implicitly shareable, a mechanism is required to locate a given Domain, based on its identity (i.e., its name and optional Context). The DomainHome interface should be implemented by a Singleton class, so that can be shared between all threads in a given Java virtual machine.

The DomainHome implementation needs to include a mechanism for it to be initialized with a default set of global Domains. In addition, some mechanism must be provided so that newly discovered Domains can be registered with the DomainHome as the presentation layer 104 encounters them. These registration methods may be exposed in the public abstract interface, or they may be hidden at a lower level of the implementation.

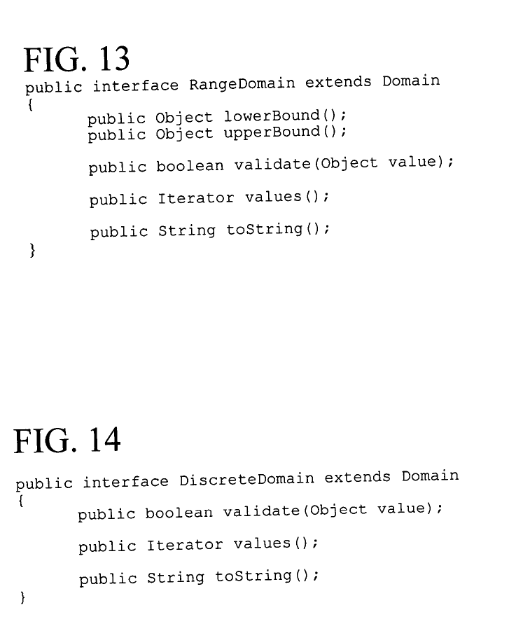

FIG. 13, RangeDomain

FIG. 13 is an example of a RangeDomain. This structure corresponds to those Domains that consist of a continuous range of values, bound by an upper and lower limit. Examples include dates and numbers (including integers). Although the “values( )” method will typically return a null result for domains of this type, it is possible that an explicit list could be returned for integer domains where the number of permitted values is small (e.g., months in the year).

FIG. 14, DiscreteDomain

FIG. 14 is an example of a DiscreteDomain. This corresponds to those domains that consist of an explicit list of permitted values, e.g., valid ISO country codes (and most other reference data items). Sub-classes of this interface should be created to support both simple static (i.e., fixed) lists of values and dynamic lists that are loaded from the database, such as corporate reference data.

RangeDomain and DiscreteDomain are presented above as two common sub-classes of Domain. These examples are thus not intended to be exclusive of the sub-classes of Domain. Further sub-classes may be added by one skilled in the art after studying this specification.

The next section presents core use cases. This section walks through a number of Use Cases that provide abstractions of the types of interaction that will occur between the presentation layer and business layer service. These are expressed in terms of the various classes described above, in connection with FIGS. 3-14.

The use cases are presented in the approximate order in which they would occur in real-time, starting from the system start-up, followed by the user log-on, leading through to the point at which business functions are invoked by the user. Each use case is preceded by a heading and includes a table illustrating the use case.

Presentation Layer is Initialized

The use case of Table I may be enacted either when the presentation layer 104 is first instantiated or just before it is first used. In any case, it must be performed before any of the other use cases can be performed.

```
TABLE I
1) Presentation Layer retrieves a list of Contexts for those business
layer services that it will need to use. The mechanism for doing this
is outside the scope of this specification, but requires that suitable
constructors are available for creating the various implementations of
Context that may be required.
2) Presentation Layer creates an instance of the DomainHome (unless
one already exists) and populates it with a list of default Domains -
see comments below.
3) Retrieve the list of Domains from each Context and register them
with the DomainHome, i.e.:
  For each Context:
    Call the retrieveInitialDomains( ) method
    For each returned Domain
      Add to the DomainHome
    End For
  End For
```

Note that two “null” variants are possible: either when no Contexts exist, or when each Context returns an empty set of initial Domains. The initialization of the DomainHome FIG. 12 can be performed using the default constructor for this class, e.g., using a system property to indicate the location of one or more configuration file (probably XML-based).

Business Layer Services are Initialized

The use case in Table II may be enacted either when the business layer 106 service is first instantiated or just before it is first used. In any case, it must be performed before any of the other use cases can be performed.

TABLE II
1) Presentation Layer creates an instance of the DomainHome (unless
one already exists) and populates it with a list of default Domains.

Note that this is simply a repetition of part of the previous use case. However, it is likely that the business layer 106 service may require a different set of initial Domains to be created than are required by the presentation layer 104. Where possible, this should be accomplished by using a different configuration file, allowing for the same configuration to be used in those areas where the requirements overlap. It is therefore suggested that the configuration be structured hierarchically, using one set of files to define the individual Domains (one per Domain) and a second file to select which of these Domains are to be loaded in a particular environment.

Presentation Layer Detects New Business Layer Service

The use case of Table III is essentially a subset of the use case of Table I and arises whenever a running presentation layer 104 encounters a new business layer 106 service. As an alternative, it could be invoked using a form of lazy retrieval, which is only performed when a presentation layer needs to interact with a business layer 106 service for the first time.

```
TABLE III
1) Retrieve the list of Domains from each Context and register them
with the DomainHome, i.e.:
  Call the retrieveInitialDomains( ) method on the new Context
  For each returned Domain
    Test whether this Domain is already
    registered with the DomainHome, using “findDomain( )”
    If not found then add to the DomainHome
  End For
```

Note that a “null” variant is possible if the Context returns an empty set of initial Domains. It is suggested that the business layer 106 only provides details of the most commonly used Domains, and that the mechanism described below in connection with Handling Unrecognized Domains is used for those that are accessed less frequently.

Presentation Layer Requests business layer Service to Provide Initial Settings for User

The use case of Table IV is enacted whenever a user begins accessing a new business layer 106 service. Its primary purpose is to provide the presentation layer with an initial list of the business layer's functions that are available to the user. The full set of functions displayed at the presentation layer will need to consider all available business layer services. This list may be subsequently filtered further by the presentation layer 104 before being presented to the user, e.g., to take account of user preferences or other restrictions. The presentation layer 104 may use any available mechanism for presenting these functions to the user, including menus, drop-down lists and pushbuttons.

The implementation of this functionality is largely outside the control of the framework, but might use a mechanism similar to that shown in Table IV:

```
TABLE IV
1) Presentation Layer retrieves current user's Context for the
business layer service that is to be initialised.
2) Presentation Layer calls the retrieveInitialDataset( ) method on
this class, passing in the current user id.
3) The returned DataSet is stored somewhere in the user's session, so
that it may be retrieved later.
4) Display the available functions, i.e.:
  For each Item at the top level of the DataSet
    If this is a FunctionItem then
      If it is callable then
        Display the function name in such a manner
        that, if selected by the user, it can be
        matched back to the corresponding Function
        object in the current DataSet.
      End If
    End If
  End For
```

“Pull” Type Processing

The use case of Table IV relies on the business layer 106 service to “push” the available functions onto the presentation layer 104. In practice, it is likely that the presentation layer 104 will have foreknowledge of the functions that are available and a view on how this should be presented to the user. In this case, the last step of the use of Table IV case might be expressed as follows:

Using the current DataSet, repeat the use case of Table V for each required function:

```
TABLE V
1) Call findFunctionItem( ) on the DataSet, using the previously agreed
function name
2) If the result is not null and isCallable( ) then
    Display the function name in such a manner
    that, if selected by the user, it can be
    matched back to the corresponding Function
  object in the current DataSet.
  End If
```

A trivial extension of this behavior might be to display the function in a different format if it is not available—e.g., “grayed-out,” as they would in a standard Windows GUI.

Presentation Layer Request Business Layer Service to Provide Initial Data for User

A recurring pattern that arises in the context of the existing client service portal is for the user to be presented with an initial set of data, presented alongside the function with which it is associated. As an example, one of the functions might be a search facility, with the associated data being a set of search criteria, some of which may be empty, while others may be set to default values (either defined globally or user-specific).

Fortunately, this scenario can easily be accommodated within the framework of the exemplary embodiment of this invention, by taking advantage of the fact that it allows for both functions and data structures to be nested. Using this fact, a suitable sequence of operations might be the following.

Using the current DataSet, repeat the use case of Table VI for each required top-level function:

TABLE VI

```
1) Call findDataItem( ) on the DataSet, using the previously agreed
data item name (with the function being implied)
2) If the result is not null and is a DataSet then
  Call findFunctionItem( ) on the returned DataSet, using
  the previously agreed function name.
  If the result is not null and isCallable( ) then
    Display the DataItems within this DataSet, e.g., using a
    “pull” mechanism to retrieve each value in turn.
    Display the function name in such that, if selected
    by the user, it will cause the associated data and function
    details to be sent back to the presentation layer to that
    it can be matched back to the corresponding Function
    object in the DataSet.
  End If
End If
```

Note that this implementation uses a “pull” approach, since this will probably easier to manage in this type of scenario. However, a “push” approach could become feasible if standard practices become well established.

If any of the DataItems refers to a Domain that is not recognized in presentation layer 104, then presentation layer 104 needs to query the business layer 106 service for further details. It is suggested that in this case a stub Domain is created inside the DomainHome (to ensure that subsequent references within this result are satisfied). The “stubbed” Domains can then be resolved once the current operation has completed, by presentation layer 104 by invoking the “retrieveNamedDomains( )” method on the associated Context.

One option would be to perform this retrieval immediately after the main DataSet has been retrieved. Alternatively, a “lazy” approach could be used, in which this retrieval is only performed if presentation layer 104 attempts to perform some operation on the Domain that requires data from business layer 106. The decision between these two options is outside the scope of this specification, since it is essentially an implementation decision within the presentation layer 104, and thus within the ability of one of ordinary skill in the art after studying this specification.

Presentation Layer Submits Function Request to Business Layer Service

The use case of Table VII follows from the previous two (Tables V and VI) and typically is invoked once the user has selected the required operation from the display that is presented to them. It assumes that presentation layer 104 has some mechanism for matching this operation (and any associated data) back to the required function within the current DataSet, e.g., by using the fully qualified name of the function (see Appendix A).

TABLE VII
1) Use the name of submitted operation to locate the Function within
the current DataSet
2) Take any data values provided in the submitted operation and use
these to update the data in the DataSet.
3) Invoke the Function and its associated DataSet on the Context with
which these are associated.

The data update operations will probably be performed relative to the selected Function item, to allow for repeating elements within the DataSet. As an example, if the function was associated with the third child DataSet within the top level DataSet then it may be assumed that most if not all of the data values provided will only need to be applied to this entry.

Presentation Layer Receives Results from Business Layer Service

If it is assumed that all Functions return a DataSet as their result then the core process simply becomes one of replacing the previous DataSet with the returned value.

The situation is complicated somewhat if a requirement exists to provide “Backtracking” functionality, as shown in the following example of Table VIII:

TABLE VIII

| | Available | User Selects | Result of |
|---|---|---|---|
| Current DataSet | Functions | Function | Function |
| AA | A1, A2, A3 | A3 | BB |
| BB | B1, B2, B3 | B2 | CC |
| CC | C1, C2, C3 | C1 | DD |

User selects BACK function at this point (i.e. after DD has
been displayed) Result should be to re-display ‘CC’

| | | | |
|---|---|---|---|
| DD | D1, D2, D3 | <BACK> | CC |

One method for implementing this functionality is to maintain a list of all DataSets that had been provided during the lifetime of a user session. In this case, a “Forward” function could also be made available, providing that the current DataSet was not deleted whenever a “Back” occurred. The major downside of this approach is that it may potentially require a very large amount of memory to store the complete set of DataSets—which may themselves be quite large in some cases.

A more practical approach is probably to only allow a limited amount of backtracking, e.g., by restricting this facility to a small subset of the functions. However, the manner in which this is configured and implemented is outside the scope of this specification and will be apparent to one skilled in the art after studying this specification.

Presentation Layer Invokes Local Function on Results

For some functions it may be appropriate for them to be invoked directly on the DataSet, without the need to interaction with business layer 106 services. Examples of this sort of function include sorting and filtering of previous DataSets.

FIG. 6 and the accompanying text indicates how this Function facility may be indicated, by providing predicates isLocal( ) and isRemote( ) on the Function class. Although local functions might also be available remotely in some cases, this is not expected to be the usual situation. The reasons for this include:

For consistency, it would generally require the entire DataSet to be sent back to business layer 106 services, which would typically be an inefficient operation.

The alternative would be for business layer services to either be forced to repeat the previous function in order to re-generate the DataSet—with all of the associated overhead—or for business layer 106 to retain the previous result state, which goes against design principles.

The concept of local functions complicates the implementation of “Back Tracking” (see previous heading), because it either requires multiple copies of the same DataSet to be held, or assumes that some form of local “Undo” facility is available on DataSets (at least for a subset of local functions). Initially, it is assumed that the former method is used, which probably requires DataSets to support cloning, so that a copy of the DataSet can be taken prior to any local functions being applied.

Integrating the Framework with Different Transports

The preceding sections of this document describe a framework that can represent the typical exchanges that need to occur between a presentation layer and one or more business layer services. These discussions have simply assumed that some mechanism will exist to allow instances of the various classes to be transported between the presentation layer and business layer services. The purpose of this section is to consider the manner in which this may be achieved and the approaches that may be used to support this.

FIG. 15 shows a conventional layered architecture that indicates the various stages through which any communication 1500 must pass, starting at the core presentation logic 1502 or business logic 1504, passing through the interfacing framework described above 1506, and finally passing through an “adapter” layer 1508 and 1510 which integrates the framework with the underlying transport 1512.

Although the use of Java implies that a number of transports might be used, it is recommended that SOAP (the Simple Object Access Protocol) is used for the initial implementation. The reasons for this decision include:

SOAP is the strategic choice for this type of communication within the PTP

SOAP is the de facto choice for Web services, which is an area into which this solution would naturally fit, moving forward.

SOAP messages are human-readable, which should simplify debugging

SOAP is relatively simply to implement, e.g., using 3^{rd} party libraries, such as the Apache “Axis” framework

SOAP interfaces well with both EJB's and servlet-based approaches (e.g., using Struts), which are likely to be a common mechanism for implementing business layer services.

Therefore, for the rest of this section, it is assumed that the transport will be based on SOAP. Furthermore, it will be assumed that this is based on the Apache Axis framework, though with the expectation that it would be reasonably straightforward to migrate to any other Java/SOAP framework (because most of the functionality is essentially driven by the SOAP standard). Details about the Apache “Axis” framework may be found at the following website: http://ws.apache.org/axis/index.html. Details about the Apache “Struts” framework may be found at the following website: http://jakarta.apache.org/struts/index.html.

If the classes in the framework are developed as well-formed java Beans (i.e., using correctly named getters and setters) then the adapters can be provided by simply making use of the Axis “BeanSerializer” and “BeanDeserializer” classes. These classes use the Java Reflection facility to dynamically associate SOAP content with Java properties, requiring minimal coding effort on the part of the developer.

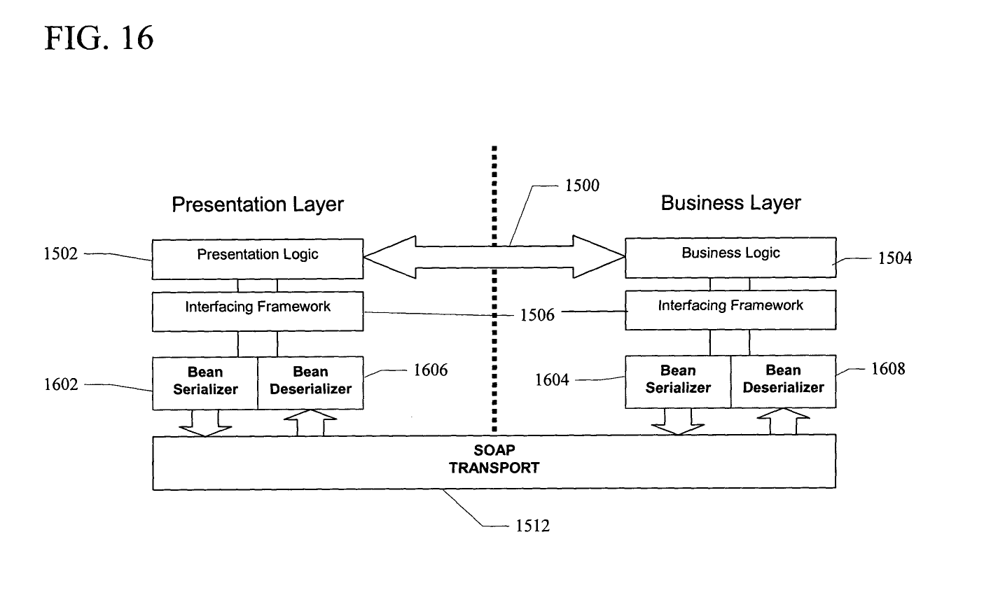

FIG. 16 demonstrates the way in which this facility is integrated into the communications architecture. The BeanSerializer 1602, 1604 takes the various class instances that are used to implement the framework and serializes them into XML, using standard getter methods to read the class state. At the receiving end, the BeanDeserializer 1606, 1608 reads the SOAP/XML and constructs the necessary class instances, using the various setter methods to initialize the class state, based on the contents of the SOAP packet. Note that the choice of which serializer to use is determined using an XML configuration file, which simply associates serializes with Java classes. The default bean serializer is typically used if no alternative is explicit defined.

In addition to using the bean serializer provided as part of the Axis package, it is possible to configure the system to use custom serializers and de-serializers. This technique is typically used for Java classes that do not adhere to the standard bean naming convention. However, it also provides an interesting option, in which the presentation layer and business layer services employ different Java classes, using the framework described in this document to act as the intermediate form.

As an example, in order to reduce the changes in the client services portal of the business layer service, it is desirable if this could continue using its existing set of classes to represent submitted requests and returned result sets. In contrast, it would be helpful if the presentation layer could use the more abstract representation described in this specification.

It is therefore proposed that a custom serializer and de-serializer are developed as part of the framework that will permit arbitrary Java beans to be serialized in a form that conforms to the format used by the standard Axis equivalents.

As an example, a standard “settlement search” facility within a business layer service might take a “SettlementSearchBean” as its input and return a “SettlementSearchResultsBean.” Using the above approach, the presentation layer could create a DataSet holding the data required by the SettlementSearchBean, without the need for it to explicitly know about this class. The DataSet could then be converted to SOAP/XML and sent to the business layer service in the standard manner, using the standard bean serializer. Once received at the business layer level, the custom de-serializer could be used to read the XML content to create and populate a “SettlementSearchBean,” as required by the business layer. The reverse sequence would occur on the return trip, with the “SettlementSearchResultsBean” being converted into XML/SOAP, using the custom serializer and converted back into DataSet form at the presentation layer, using the standard de-serializer.

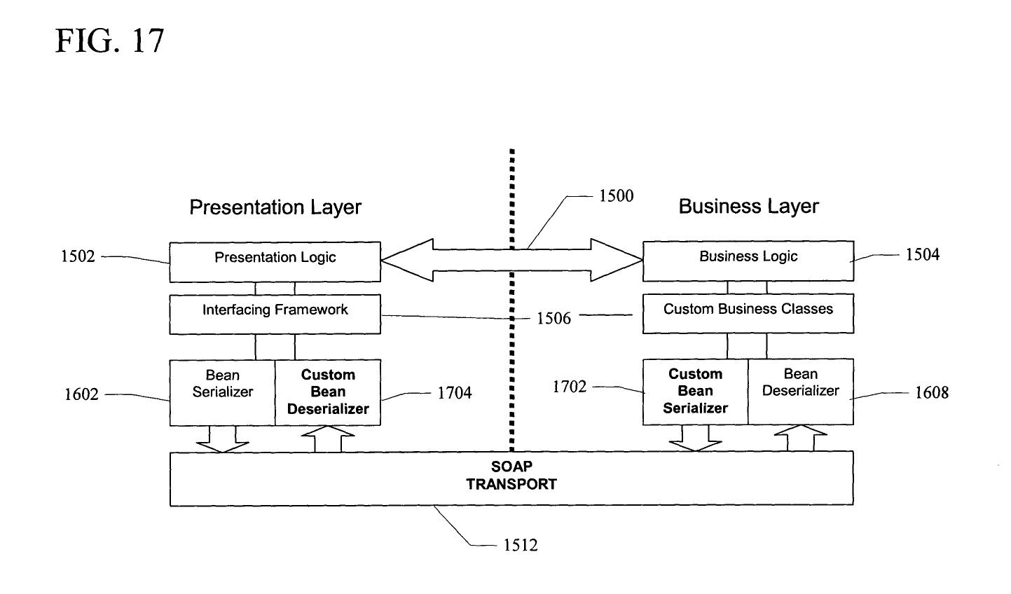

FIG. 17 provides an amended architecture that shows the business layer service using a custom set of java business classes 1702, 1704, whilst allowing the presentation layer to take advantage of the flexibility provided by the framework described in this document.

The remainder of this section considers a number of issues that arise if this approach is adopted.

Identifying the Business Class

The standard BeanDeserializer class determines which Java classes to instantiate by inspecting the contents of the SOAP packet for the name of the class. Since the default behaviour is for this transformation to be done using the classes described in this document, we cannot use this field to hold the details of the underlying “business class.” The simplest way around this issue would therefore be for a new property to be added to the classes described in this document, which could hold the name of the business class.

If the standard serializer is used then this will simply be transported as a Java String, but will otherwise be ignored. The “special” meaning of this field will only be apparent to the custom de-serializer, which will use it to locate the required class. Likewise, it can be populated by the custom serializer, using the name of the class that is being serialized. It is recommended that this property is omitted from the abstract interfaces so that it is effectively hidden from the client classes of the framework.

Identifying When the Custom De-Serializer Should be Used

For the purposes of discussion this section will focus on the DataSet class. Consider the situation if receiver is configured to use the default bean de-serializer for all DataSet classes. In this case, the receiver will convert all serialised forms of this class into an instance of the DataSet class. Conversely, if receiver is configured to use the custom de-serializer then all DataSets will be converted into an instance of the underlying business class. A problem arises if a mixed approach is required, in which a combination of the two is required.

It is therefore recommended that the configuration file is extended to allow those classes that require custom processing to be listed explicitly. If the custom de-serializer encounters a serialised class that is not in this list then it can simply delegate the processing to the standard bean de-serializer.

Notifying the Presentation Layer of the DataSet Contents

The preceding discussions have considered two approaches for the presentation layer to retrieve information from the message that it is sent by the business layer service: a “push” approach, in which the presentation layer processing is driven by the meta data inside the message; and a “pull” approach, which requires the presentation layer to have prior knowledge of the contents of the message.

No issue arises if the “push” approach is adopted, since this is indifferent to the source of the data. However, if a “pull” approach is used then this presumes that the presentation layer is somehow aware of the message content—which begs the question as to how this knowledge is transferred.

The question becomes more complicated if we use the mixed serialisation approach described in this section, since this implies that a java class already exists (in the business layer service) that explicitly defines the attributes of the message. This leads to the obvious question: Why not simply use the business class in the presentation layer?

In fact, there are a number of arguments against this approach:

It introduces a tight coupling between the presentation layer and the business layer services.

It makes business-specific functionality available in the presentation (assuming that the business classes include some behaviours).

It bypasses the mechanism described in this document that allows the business layer service to selectively reveal functionality to the presentation layer, based on the current context.

It leads to the presentation layer using a hard-coded approach, which reduces the degree to which presentation layer code can be re-used.

Instead, it is recommended that the presentation layer uses a configuration file approach to drive its behaviours. As an example, if a page needs to be populated with a table of data, then a configuration file could be used to hold the names of each of the columns that need to be displayed. The presentation layer can then iterate through this file and retrieve the necessary data from the current DataSet. This approach will allow the generic “table-management” logic to be re-used across any tabular data, merely by creating a new configuration file.

Despite this, it is possible that, over time, a code-generation facility will evolve, in which the initial “default” configuration file is generated automatically, either from the business layer Java code or from the information held in the SOAP message. However, it is recommended that this mechanism is only implemented when the pattern of usage becomes clearer.

Setting the Available Functions in the Business Layer Service

If the business layer service is generating the result data “long-hand” then it is reasonable that the specification of the available functions is incorporated in a similar fashion. However, if a custom serializer is being used to convert Java classes into XML form, then it might be more appropriate for this to somehow detect the available functions in the java class and to add these to the response as necessary.

The main problem that arises is how to determine which business layer functions are available at any given time, since this is likely to vary during the lifetime of the system, based on the current business context. Although it is suggested that this could eventually be provided by a configuration file, it is recommended that a “long-hand” approach continues to be applied until the usage is clearer.

To support this, it is suggested that the custom serializer checks each bean to determine if a “functionSetter” method is provided by the class (based on a pre-defined method name and signature). If this is the case, then the serializer should call this method in such a manner that it can set the available functions for the current DataSet. This could be done in a number of ways, including passing the DataSet to the function, or taking the results returned by the function and incorporating them into the DataSet.

It is to be understood that the above-described embodiment is merely illustrative of the present invention and that many variations of the above-described embodiment can be devised by one skilled in the art without departing from the scope of the invention. It is therefore intended that such variations be included within the scope of the following claims and their equivalents.

```
APPENDIX A
  The preceding discussions have introduced the concept of the DataSet as an hierarchical
tree of Items, each of which is identified by a name. Further operations exist that allow Items to
be retrieved by name.
  The simplest option would be for items to be given trivial names “AA,” “BB” or “CC”
that would allow the immediate descendants of an Item to be read. However, a more flexible
approach would be to provide a hierarchical naming convention that allowed arbitrary Items to
be retrieved by name, similar to that used for directory structures or the XPath convention.
Details regarding the XPath convention may be found at the website:
http://www.w3.org.TR.xpath.
  As an example, the name:
    AA.BB.CC
  Could be used to refer to the Item named “CC”, which is contained within the DataSet
“BB” within the DataSet “AA” (noting that Items which contain other Items must be DataSets).
  Note that the use of a “dot” separator helps to distinguish such names from XPaths or
directories, which could help avoid confusion in the future.
  A further extension, to allow for repeating groups, might use a notation of the form:
    AA.BB[3].CC
  To indicate that this is a reference to the third Item named “BB” within “AA.”
  In order to support the concepts of both absolute and relative addressing it is suggested
that such names are assumed to be absolute, unless they begin with a period, e.g.:
    AA.BB  An absolute address
    .XX.YY  A relative address
  Note that the concept of relative addresses assumes that there is some mechanism
(outside the scope of this appendix) for identifying the point from which these relative addresses
are to be calculated.
  Further note that the suggestions presented in this appendix are not integral to this
specification and that numerous alternatives will be apparent to one skilled in the art.
```

What is claimed is:

1. A method for use in a distributed processing system to effect an interface between a business layer and a presentation layer comprising:
defining a data set structure for use in both the business layer and the presentation layer, said data set structure comprising hierarchical organizational information for data and functions;
populating a business layer data set in said business layer according to said data set structure, said business layer data set comprising data and functions available for use in said business layer; and
populating a presentation layer data set in said presentation layer according to said data set structure from said business layer data set, said presentation layer data set comprising data and functions available for use in said presentation layer.

2. A method in accordance with claim 1 wherein defining a data set structure comprises defining a plurality of items comprising a plurality of data items and a plurality of function items.

3. A method in accordance with claim 2 wherein defining a plurality of data items comprises defining a data value for each of said plurality of data items.

4. A method in accordance with claim 2 wherein defining a plurality of data items comprises defining a domain for each of said plurality of data items.

5. A method in accordance with claim 4 wherein defining a domain for each of said data items comprises defining a domain home for each of said plurality of data items.

6. A method in accordance with claim 4 wherein defining a domain for each of said data items comprises defining a context for each of said plurality of data items.

7. A method in accordance with claim 4 wherein defining a domain for each of said data items comprises defining a range domain for each of said plurality of data items.

8. A method in accordance with claim 4 wherein defining a domain for each of said plurality of data items comprises defining a discrete domain for each of said plurality of data items.

9. A method in accordance with claim 2 wherein defining a plurality of function items comprises defining a function for each of said plurality of function items.

10. A method in accordance with claim 2 wherein defining a plurality of function items comprises defining a function set for each of said plurality of function items.

11. An apparatus for use in a distributed data processing system comprising:
a data set for storing available data and identification of function calls;
a presentation layer configured to store data and identification of function calls that are available for use by a user in accordance with said data set; and
a business layer configured to store data and identification of function calls that are available for use by said presentation layer in accordance with said data set.

12. An apparatus in accordance with claim 11 wherein said presentation layer is further configured to request data and identification of function calls from said business layer and to store said data and identification of function calls in accordance with said data set so that data and identification of function calls of said business layer can be available to said presentation layer.

13. An apparatus in accordance with claim 12 wherein said business layer comprises a plurality of processors wherein each of said processors is configured to store data and identification of function calls that are available for use by said presentation layer in accordance with said data set wherein each of said processors provides unique data and identification of function calls to said presentation layer.

14. An apparatus in accordance with claim 13 wherein business layer function calls are available to said presentation layer for execution at said presentation layer via said data set.

15. An apparatus in accordance with claim 13 wherein business layer function calls are available to said presentation layer for execution at said business layer via said data set.

16. An apparatus in accordance with claim 13 wherein business layer function calls are available at said presentation layer for execution at both said presentation layer and at said business layer via said data set.
